(19) United States
(12) Patent Application Publication
(10) Pub. No.: US 2025/0063630 A1
(43) Pub. Date: Feb. 20, 2025

(54) DEVICES, METHODS, APPARATUSES AND COMPUTER READABLE MEDIUMS FOR CELL DISCONTINUOUS TRANSMISSION AND RECEPTION

(71) Applicant: Nokia Technologies Oy, Espoo (FI)

(72) Inventors: Naizheng ZHENG, Beijing (CN); Chunli WU, Beijing (CN); Ahlem KHLASS, Massy (FR); Daniela LASELVA, Klarup (DK)

(21) Appl. No.: 18/802,127

(22) Filed: Aug. 13, 2024

(30) Foreign Application Priority Data
Aug. 17, 2023 (WO) PCT/CN2023/113435

(51) Int. Cl. H04W 76/28

(52) U.S. Cl. CPC H04W 76/28

(57) ABSTRACT

Various example embodiments relate to devices, methods, apparatuses and computer readable mediums for cell discontinuous transmission or reception. A terminal device may receive a cell configuration for discontinuous transmission or reception from a network device. The configuration may define a discontinuous transmission or reception pattern including an active period and a non-active period, a first periodicity for transmission or reception during the active period, and a second periodicity for transmission or reception during the non-active period. When the discontinuous transmission or reception is activated, the terminal device may perform reception or transmission of a signal or channel in the first periodicity during the active period, and perform reception or transmission of the signal or channel in the second periodicity during the non-active period.

### TECHNICAL FIELD

Various example embodiments described herein generally relate to communication technologies, and more particularly, to devices, methods, apparatuses and computer readable mediums for cell discontinuous transmission (DTX) and discontinuous reception (DRX).

### BACKGROUND

Certain abbreviations that may be found in the description and/or in the figures are herewith defined as follows:
CSI-RS Channel State Information Reference Signal
DCI Downlink Control Information
DRX Discontinuous Reception
DTX Discontinuous Transmission
MAC Media Access Control
NES Network Energy Saving
RLM Radio Link Management
RRC Radio Resource Control
SFN System Frame Number
TRS Tracking Reference Signal
UE user equipment

5G New Radio (NR) is designed to enable denser network deployments for higher capacity and performance, which implies increasing energy consumption that adds up to a significant part of operator's expenses, and also leads to environment impacts. Network energy saving (NES) is becoming one of the top priorities of the telecom industry.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a terminal device is provided. The terminal device may comprise at least one processor and at least one memory. The at least one memory stores instructions which, when executed by the at least one processor, cause the terminal device at least to receive from a network device a configuration for discontinuous transmission or reception of a cell supported by the network device. The configuration for discontinuous transmission or reception defines a discontinuous transmission or reception pattern including an active period and a non-active period, a first periodicity for transmission or reception during the active period, and a second periodicity for transmission or reception during the non-active period. The terminal device is further caused to receive from the network device an indication to activate the discontinuous transmission or reception in the cell, perform reception or transmission of a signal or channel in the first periodicity during the active period, and perform reception or transmission of the signal or channel in the second periodicity during the non-active period.

In a second aspect, an example embodiment of a network device is provided. The network device may comprise at least one processor and at least one memory. The at least one memory stores instructions which, when executed by the at least one processor, cause the network device at least to transmit to a terminal device a configuration for discontinuous transmission or reception of a cell supported by the network device. The configuration for discontinuous transmission or reception defines a discontinuous transmission or reception pattern including an active period and a non-active period, a first periodicity for transmission or reception during the active period, and a second periodicity for transmission or reception during the non-active period. The network device is further caused to transmit to the terminal device an indication to activate the discontinuous transmission or reception in the cell, perform transmission or reception of a signal or channel in the first periodicity during the active period, and perform transmission or reception of the signal or channel in the second periodicity during the non-active period.

Example embodiments of methods, apparatuses and computer readable mediums for cell discontinuous transmission and/or reception are also provided. Such example embodiments generally correspond to the above example embodiments of the terminal device and the network device, and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating a communication network in which example embodiments of the present disclosure can be implemented.

FIG. 2 is a message flow chart illustrating a process according to an example embodiment of the present disclosure.

FIG. 3A is a schematic diagram illustrating an example of cell discontinuous transmission or reception according to an example embodiment of the present disclosure.

FIG. 3B is a schematic diagram illustrating another example of cell discontinuous transmission or reception according to an example embodiment of the present disclosure.

FIG. 3C is a schematic diagram illustrating another example of cell discontinuous transmission or reception according to an example embodiment of the present disclosure.

FIG. 4 is a schematic block diagram illustrating an apparatus according to an example embodiment of the present disclosure.

FIG. 5 is a schematic block diagram illustrating an apparatus according to an example embodiment of the present disclosure.

FIG. 6 is a schematic block diagram illustrating devices in a communication system according to an example embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which terminal devices can access the network or receive services. The network device may be commonly referred to as a base station. The term “base station” used herein can represent a node B (NodeB or NB), an evolved node B (eNodeB or eNB), or a gNB or an ng-eNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network device or with each other. Examples of the terminal device can include a mobile phone, a mobile terminal, a mobile station, a subscriber station, a portable subscriber station, an access terminal, a computer, a wearable device, an on-vehicle communication device, a machine type communication (MTC) device, an internet of things (IoT) device, an internet of everything (IoE) device, a device-to-device (D2D) communication device, a vehicle to everything (V2X) communication device, a sensor and the like. The term “terminal device” can be used interchangeably with UE, a user terminal, a mobile terminal, a mobile station, or a wireless device.

5G NR base stations have much higher power consumption than 4G LTE base stations, and considering higher density, the overall power consumption of 5G networks may be multiple times of 4G networks. Therefore, network energy saving (NES) has become a top priority for the mobile communication system. A solution for reducing network power consumption is to configure discontinuous transmission (DTX) and discontinuous reception (DRX) for a serving cell. The base station may perform transmission or reception normally during an active period of cell DTX or DRX, and it may omit the transmission or reception during a non-active period of cell DTX or DRX for power saving. The non-active period may be short or long, depending on a network energy saving strategy implemented at the network. If the non-active period is short, no transmission and reception during the non-active period may not significantly affect performance of UEs camping on the cell. However, if the non-active period is long and there is no transmission and reception during the non-active period, UE performance could be compromised seriously. For instance, if a UE does not receive a periodic channel state information reference signal (CSI-RS) configured for tracking (also referred to as tracking reference signal, TRS) from the network for a long non-active period, there will be a serious impact on UE transmission and reception performance due to time and frequency offset between the UE and the network.

Example embodiments of the present disclosure propose a flexible mechanism for cell DTX and DRX, in which transmission and reception may be configured for a non-active period, and optionally signals and/or channels that are expected to be transmitted or received during the non-active period may be also configurable. For instance, the network may configure sparse transmission or reception with longer periodicity for the non-active period than that for the active period. The network may also configure certain signals and/or channels to be transmitted or received during the non-active period in order to ensure UE performance. Hence a desirable active/non-active pattern for cell DTX or DRX can be applied to achieve a needed power saving level, and UE can align its behaviour to the network based on the cell DTX or DRX configuration.

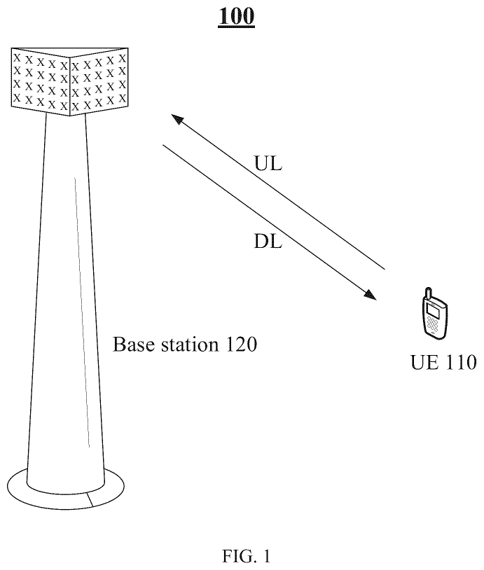

FIG. 1 illustrates a schematic diagram of a communication network 100 in which example embodiments of the present disclosure can be implemented. The communication network 100, which may be a part of a larger network or system, may include one or more user equipment (UEs) 110 and one or more base stations (BSs) 120 (also referred to as base transceiver station, BTS). FIG. 1 shows one base station 120 and one UE 110 as an example. The base station 120 may serve a plurality of cells (not shown), and the UE 110 may camp in a cell supported by the base station 120. The UE 110 may establish a radio resource control (RRC) connection with the base station 120 to communicate with the base station 120. For instance, the UE 110 may receive transmissions on downlink (DL) channels from the base station 120 and/or transmit transmissions on uplink (UL) channels to the base station 120.

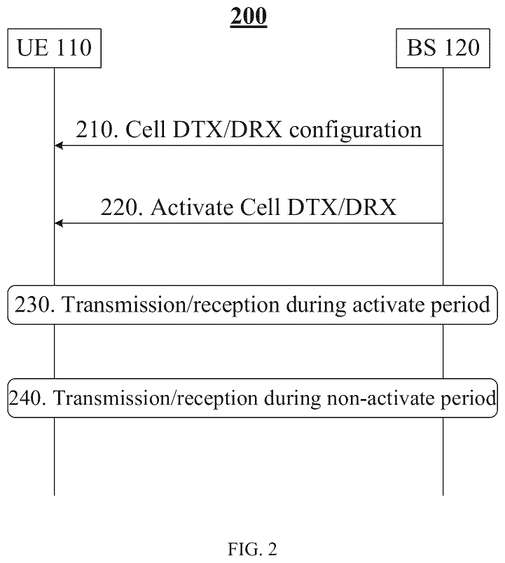

As mentioned above, discontinuous transmission (DTX) and/or discontinuous reception (DRX) may be configured for a cell to reduce network power consumption. FIG. 2 is a message flow chart illustrating a process 200 for cell DTX or DRX according to an example embodiment of the present disclosure. The process 200 may be performed at the UE 110 and the base station 120 in the communication network 100 shown in FIG. 1.

Referring to FIG. 2, at 210, the base station 120 may transmit a DTX or DRX configuration for a cell to the UE 110 camping on the cell. The DTX or DRX configuration may be transmitted via RRC signaling and it may define at least a DTX or DRX pattern, which includes an active period and a non-active period alternately arranged in the time domain. The base station 120 may determine a duration of the active period and a duration of the non-active period based on a network energy saving (NES) strategy implemented at the base station 120. For instance, the non-active period may be configured with a longer duration for a higher energy saving level. The DTX or DRX configuration may further define a first periodicity for transmission or reception during the active period, and a second periodicity for transmission or reception during the non-active period. In an example embodiment, the DTX or DRX configuration may define only the first periodicity, and the second periodicity may be indicated by specifying one or more occasions of the first periodicity to be skipped during the non-active period. The second periodicity may be greater than or at least equal to the first periodicity. In an example embodiment, the second periodicity may be N times of the first periodicity where N is an integer greater than or equal to 1. Some examples of the first periodicity and the second periodicity may be discussed in detail below. In an example embodiment, the DTX or DRX configuration may define multiple DTX or DRX patterns, but only one of the patterns can be activated at a time, as discussed below.

In an example embodiment, the DTX or DRX configuration may further define one or more signals or channels to be transmitted or received during the active period, and/or one or more signals or channels to be transmitted or received during the non-active period. In an example, the one or more signals or channels to be transmitted or received during the non-active period may be selected from the one or more signals or channels to be transmitted or received during the active period. In an example embodiment, the one or more signals or channels to be transmitted or received during the active period may be pre-configured/pre-defined at the base station 120 and the UE 110, and the cell DTX or DRX configuration may indicate only the one or more signals or channels to be transmitted or received during the non-active period. For example, in case of cell DTX, the one or more signals or channels to be transmitted or received during the non-active period may include at least one of the following:
Periodic or semi-persistent CSI-RS configured for CSI reporting;
CSI-RS configured for radio resource management (RRM), radio link management (RLM), beam failure detection (BFD), beamforming (BF), or tracking;
Physical downlink control channel (PDCCH) in UE-specific search space (USS);
PDCCH in Type-3 common search space (CSS); and
Positioning reference signal (PRS).

In case of cell DRX, the one or more signals or channels to be transmitted or received during the non-active period may include at least one of the following:
Periodic or semi-persistent CSI report;
Periodic or semi-persistent sounding reference signal (SRS); and
Hybrid automatic repeat request (HARQ) feedback for semi-persistent scheduling (SPS) physical downlink shared channel (PDSCH).

After transmitting the cell DTX or DRX configuration to the UE 110, the base station 120 may instruct the UE 110 to activate the cell DTX or DRX at 220, when the base station 120 decides to enter into the DTX or DRX mode for power saving. In an example embodiment, the base station 120 may send an indication of activating the cell DTX or DRX to the UE 110 via downlink control information (DCI) or media access control (MAC) control element (CE) signaling. In response to the indication received from the base station 120, the UE 110 may activate the cell DTX or DRX mode.

Then the base station 120 and the UE 110 may operate in the cell DTX or DRX mode. For instance, in the cell DTX mode, the UE 110 may receive downlink (DL) transmissions transmitted from the base station 120 in the first periodicity during the active period at 230, and receive DL transmissions transmitted from the base station 120 in the second periodicity during the non-active period at 240. In the cell DRX mode, the UE 110 may transmit uplink (UL) transmissions to the base station 120 in the first periodicity during the active period at 230, and transmit UL transmissions to the base station 120 in the second periodicity during the non-active period at 240.

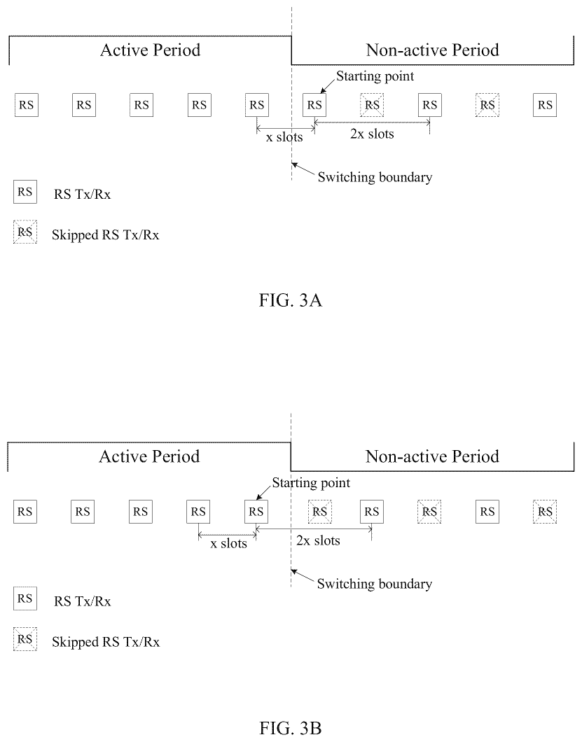

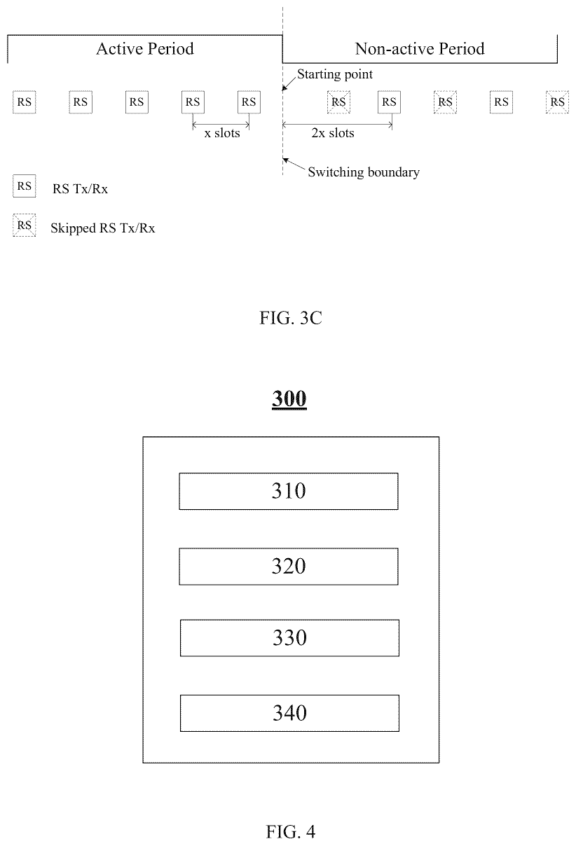

FIG. 3A, FIG. 3B and FIG. 3C illustrate some examples of transmission or reception occasions during cell DTX or DRX according to example embodiments of the present disclosure, in which a plurality of DL RS transmission occasions for cell DTX or UL RS transmission occasions for cell DRX are configured during the active period and the non-active period. For convenience of description, hereinafter the examples shown in FIGS. 3A-3C will be described in the context of cell DTX where the DL RS transmission occasions are configured, but it would be appreciated that the examples are also applicable to cell DRX where the UL RS transmission occasions are configured.

Referring to FIG. 3A first, there is shown an active period and a non-active period for cell DTX or DRX, with a switching boundary from the active period to the non-active period. As mentioned above, a pattern of the active period and the non-active period may be configured in the cell DTX or DRX configuration and transmitted to the UE 110 via RRC signaling. In an example embodiment, the base station 120 may indicate the switching boundary to the UE 110 in the cell DTX or DRX configuration, or via L1 signaling e.g. the dedicated DCI for cell DTX or DRX activation.

As shown in FIG. 3A, a reference signal (RS) may be transmitted in the first periodicity during the active period, and transmitted in the second periodicity during the non-active period. In the example shown, the RS transmission occasions of the second periodicity overlap with the RS transmission occasions of the first periodicity, so that the UE 110 can determine the RS transmission occasions of the second periodicity by simply skipping certain RS transmission occasions of the first periodicity. For instance, the first periodicity and the second periodicity may be configured with a common offset relative to a reference time point. The reference time point may be for example a system frame number (SFN), a subframe number, or a symbol number. In an example, a time reference for UE connected DRX (C-DRX) may be used as the reference time point for the first periodicity and the second periodicity. The second periodicity may be configured to N times of the first periodicity where N is an integer greater than or equal to 1, and the second periodicity may be applied from a certain RS transmission occasion of the first periodicity, so that the RS transmission occasions of the second periodicity overlap with the RS transmission occasions of the first periodicity. In the example shown, the first periodicity has a period of x slots, the second periodicity has a period of 2x slots (N=2), and the second periodicity is applied from the first RS transmission occasion of the first periodicity during the non-active period, which is also referred to as a starting point for the second periodicity. The UE 110 monitors the RS transmissions occasions in the active period and the first RS transmission in the non-active period based on the first periodicity, but afterwards the UE 110 will skip monitoring every second RS transmission occasion during the non-active period. At the network side, the base station 120 transmits RS transmissions based on the first periodicity until the first RS transmission occasion in the non-active period, and afterwards the base station 120 will skip every second RS transmission occasion during the non-active period.

FIG. 3B illustrates another example of cell DTX or DRX according to an example embodiment of the present disclosure. In the example shown in FIG. 3B, the second periodicity is applied from the last RS transmission occasion of the first periodicity during the active period. The UE 110 and the base station 120 will skip every second transmission occasion starting from the last RS transmission occasion during the active period. Other aspects of the example shown in FIG. 3B are similar to the example shown in FIG. 3A and a repetitive description thereof is omitted here for convenience.

FIG. 3C illustrates another example of cell DTX or DRX according to an example embodiment of the present disclosure where the RS transmission occasions of the second periodicity during the non-active period may not overlap with the RS transmission occasions of the first periodicity. For instance, the second periodicity may be configured with a separate offset relative to the reference time point, and the second periodicity may be arbitrarily configured, usually greater than or equal to the first periodicity but not limited to the above-mentioned N times of the first periodicity. In addition, the second periodicity may be applied from a time point that differs from the transmission occasions of the first periodicity. In the example shown in FIG. 3C, the second periodicity is double of the first periodicity and it is applied from the switching boundary between the active period and the non-active period. The RS transmission occasions of the second periodicity may be determined independently from the RS transmission occasions of the first periodicity, or by skipping certain transmission occasions of the first periodicity if the second periodicity is N times of the first periodicity. FIG. 3C shows the skipped RS transmission occasions of the first periodicity during the non-active period. It would be appreciated that the skipped and remained RS transmission occasions of the first periodicity during the non-active period are determined based on the separate offset and starting point configured for the second periodicity.

In the above examples shown in FIGS. 3A-3C, the first periodicity and the second periodicity may be separately defined in the cell DTX or DRX configuration, or the second periodicity may be defined in relation to the first periodicity. For instance, the second periodicity may be defined as N times of the first periodicity. In an example embodiment, the cell DTX or DRX configuration may define the second periodicity by explicitly or implicitly indicating one or more transmission occasions of the first periodicity to be skipped during the non-active period. In an example, the one or more transmission occasions of the first periodicity to be skipped during the non-active period may depend on a time length of the non-active period, the RS type, or monitoring requirements of the UE 110.

In the above examples shown in FIGS. 3A-3C, the second periodicity is applied from different starting points. For example, the second periodicity is applied from the first RS transmission occasion of the first periodicity in the non-active period in FIG. 3A, from the last RS transmission occasion of the first periodicity in the active period, and from the switching boundary from the active period to the non-active period in FIG. 3C. The starting point for the second periodicity may be defined in the above mentioned cell DTX or DRX configuration, or the cell DTX or DRX configuration may define a rule for determining the starting point of the second periodicity. In another example embodiment, the starting point or the rule for determining the starting point may be pre-configured/pre-defined at the UE 110 and the base station 120 to reduce signaling overhead therebetween.

Some examples of the rule for determining the starting point of the second periodicity will be discussed here. In an example, a time difference between the switching boundary and the first transmission occasion of the first periodicity in the non-active period may be compared with a threshold. If the time difference is less than or equal to the threshold, the first transmission occasion of the first periodicity in the non-active period is sufficiently close to the switching boundary and it may be used as the starting point from which the second periodicity is applied, as in the case shown in FIG. 3A. If the time difference is greater than the threshold, the first transmission occasion of the first periodicity in the non-active period is far away from the switching boundary, and the transmission occasion immediately before it, i.e. the last transmission occasion of the first periodicity in the active period, may be used as the starting point from which the second periodicity is applied, as in the case shown in FIG. 3B.

In another example, a time difference between the last transmission occasion of the first periodicity in the active period and the switching boundary may be compared with a threshold. If the time difference is less than or equal to the threshold, the last transmission occasion of the first periodicity in the active period is sufficiently close to the switching boundary and it may be used as the starting point from which the second periodicity is applied, as in the case shown in FIG. 3B. If the time difference is greater than the threshold, the last transmission occasion of the first periodicity in the active period is far away from the switching boundary, and the transmission occasion immediately after it, i.e. the first transmission occasion of the first periodicity in the non-active period, may be used as the starting point from which the second periodicity is applied, as in the case shown in FIG. 3A.

In another example, one of the last transmission occasion of the first periodicity in the active period and the first transmission occasion of the first periodicity in the non-active period which is closer to the switching boundary may be used as the starting point from which the second periodicity is applied. For instance, the UE 110 and the base station 120 may compare the time difference from the last transmission occasion of the first periodicity in the active period to the switching boundary with the time difference from the switching boundary to the first transmission occasion of the first periodicity in the non-active period and choose one of the two transmission occasions closer to the switching boundary as the starting point for the second periodicity.

In another example, the switching boundary from the active period to the non-active period may be used as the starting point for the second periodicity, as in the case shown in FIG. 3C.

FIG. 4 is a schematic block diagram illustrating an apparatus 300 according to an example embodiment of the present disclosure. The apparatus 300 may be implemented to comprise or to form at least a part of the UE 110 discussed above to perform at least a part of operations related to the UE 110. Since the operations related to the UE 110 have been discussed above with reference to FIGS. 1-3C, the blocks of the apparatus 300 will be described briefly here and details thereof may refer to the above description.

Referring to FIG. 4, the apparatus 300 may include a first means 310 for receiving a cell configuration for discontinuous transmission (DTX) or reception (DRX) from a network device. The cell configuration for DTX or DRX may define a DTX or DRX pattern including an active period and a non-active period, a first periodicity for transmission or reception during the active period, and a second periodicity for transmission or reception during the non-active period. The apparatus 300 may further include a second means 320 for receiving an indication to activate the DTX or DRX in the cell from the network device, a third means 330 for performing reception or transmission of a signal or channel in the first periodicity during the active period, and a fourth means 340 for performing reception or transmission of the signal or channel in the second periodicity during the non-active period.

In an example embodiment, the cell configuration for DTX or DRX may further define at least one of the following: one or more signals or channels to be transmitted or received during the active period, and one or more signals or channels to be transmitted or received during the non-active period.

In an example embodiment, the first periodicity and the second periodicity may be configured with a common offset relative to a reference time point, and the second periodicity may be N times of the first periodicity where N is an integer greater than or equal to 1, so that transmission or reception occasions of the second periodicity overlaps with transmission or reception occasions of the first periodicity.

In an example embodiment, the fourth means 340 of the apparatus 300 may apply the second periodicity from the first occasion of the first periodicity in the non-active period in a case where a time difference between a switching boundary from the active period to the non-active period and the first occasion of the first periodicity in the non-active period is less than or equal to a first threshold, or from the last occasion of the first periodicity in the active period in a case where the time difference between the switching boundary and the first occasion of the first periodicity in the non-active period is greater than the first threshold.

In an example embodiment, the fourth means 340 of the apparatus 300 may apply the second periodicity from the last occasion of the first periodicity in the active period in a case where a time difference between the last occasion of the first periodicity in the active period and a switching boundary from the active period to the non-active period is less than or equal to a second threshold, or from the first occasion of the first periodicity in the non-active period in a case where the time difference between the last occasion of the first periodicity in the active period and the switching boundary is greater than the second threshold.

In an example embodiment, the fourth means 340 of the apparatus 300 may apply the second periodicity from one of the last occasion of the first periodicity in the active period and the first occasion of the first periodicity in the non-active period which is closer to a switching boundary from the active period to the non-active period.

In an example embodiment, the second periodicity for transmission or reception during the non-active period may be indicated by specifying one or more occasions of the first periodicity to be skipped during the non-active period.

In an example embodiment, the cell configuration for DTX or DRX may further indicate a starting point or defines a rule for determining the starting point from which the second periodicity is applied. In another example embodiment, the starting point or the rule for determining the starting point may be pre-configured/pre-defined at the apparatus 300.

In an example embodiment, the fourth means 340 of the apparatus 300 may apply the second periodicity from the first occasion of the first periodicity in the non-active period, from the last occasion of the first periodicity in the active period, or from the switching boundary from the active period to the non-active period.

In an example embodiment, the second periodicity is configured with a separate offset relative to a reference time point, and the second periodicity is greater than or equal to the first periodicity.

In an example embodiment, the second periodicity is applied from the switching boundary from the active period to the non-active period.

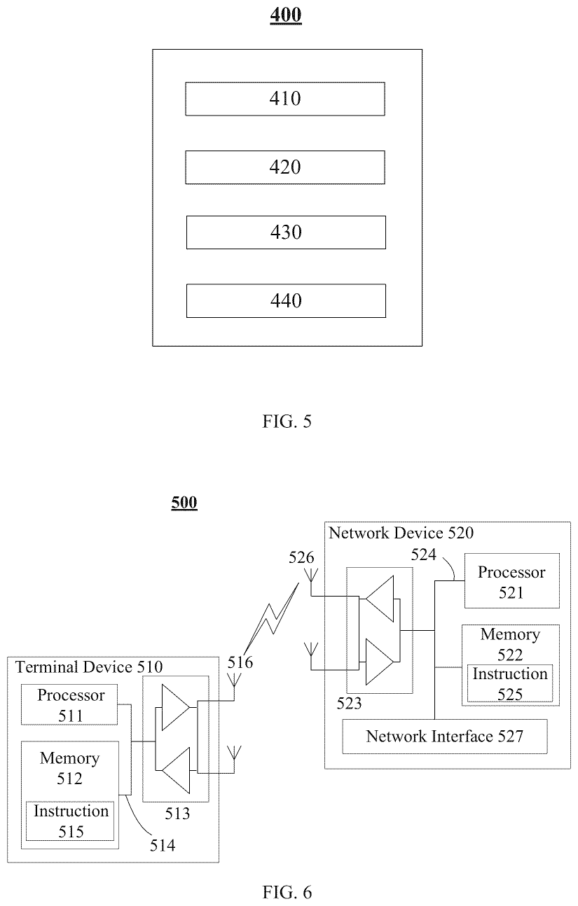

FIG. 5 is a schematic block diagram illustrating an apparatus 400 according to an example embodiment of the present disclosure. The apparatus 400 may be implemented to comprise or to form at least a part of the base station 120 discussed above to perform at least a part of operations related to the base station 120. Since the operations related to the base station 120 have been discussed above with reference to FIGS. 1-3C, the blocks of the apparatus 400 will be described briefly here and details thereof may refer to the above description.

Referring to FIG. 5, the apparatus 400 may include a first means 410 for transmitting a cell configuration for discontinuous transmission (DTX) or reception (DRX) to a terminal device. The cell configuration for DTX or DRX may define a DTX or DRX pattern including an active period and a non-active period, a first periodicity for transmission or reception during the active period, and a second periodicity for transmission or reception during the non-active period. The apparatus 400 may further include a second means 420 for transmitting an indication to activate cell DTX or DRX to the terminal device, a third means 430 for performing transmission or reception of a signal or channel in the first periodicity during the active period, and a fourth means 440 for performing transmission or reception of the signal or channel in the second periodicity during the non-active period.

In an example embodiment, the cell configuration for DTX or DRX may further define at least one of the following: one or more signals or channels to be transmitted or received during the active period, and one or more signals or channels to be transmitted or received during the non-active period.

In an example embodiment, the first periodicity and the second periodicity may be configured with a common offset relative to a reference time point, and the second periodicity may be N times of the first periodicity where N is an integer greater than or equal to 1, so that transmission or reception occasions of the second periodicity overlaps with transmission or reception occasions of the first periodicity.

In an example embodiment, the fourth means 440 of the apparatus 400 may apply the second periodicity from the first occasion of the first periodicity in the non-active period in a case where a time difference between a switching boundary from the active period to the non-active period and the first occasion of the first periodicity in the non-active period is less than or equal to a first threshold, or from the last occasion of the first periodicity in the active period in a case where the time difference between the switching boundary and the first occasion of the first periodicity in the non-active period is greater than the first threshold.

In an example embodiment, the fourth means 440 of the apparatus 400 may apply the second periodicity from the last occasion of the first periodicity in the active period in a case where a time difference between the last occasion of the first periodicity in the active period and a switching boundary from the active period to the non-active period is less than or equal to a second threshold, or from the first occasion of the first periodicity in the non-active period in a case where the time difference between the last occasion of the first periodicity in the active period and the switching boundary is greater than the second threshold.

In an example embodiment, the fourth means 440 of the apparatus 400 may apply the second periodicity from one of the last occasion of the first periodicity in the active period and the first occasion of the first periodicity in the non-active period which is closer to a switching boundary from the active period to the non-active period.

In an example embodiment, the second periodicity for transmission or reception during the non-active period may be indicated by specifying one or more occasions of the first periodicity to be skipped during the non-active period.

In an example embodiment, the cell configuration for DTX or DRX may further indicate a starting point or defines a rule for determining the starting point from which the second periodicity is applied.

In an example embodiment, the fourth means 440 of the apparatus 400 may apply the second periodicity from a first occasion of the first periodicity in the non-active period, from a last occasion of the first periodicity in the active period, or from a switching boundary from the active period to the non-active period.

In an example embodiment, the second periodicity may be configured with a separate offset relative to a reference time point, and the second periodicity may be greater than or equal to the first periodicity.

In an example embodiment, the second periodicity may be applied from a switching boundary from the active period to the non-active period.

FIG. 6 is a schematic block diagram illustrating devices in a communication system 500 according to an example embodiment of the present disclosure. As shown in FIG. 6, the communication system 500 may comprise a terminal device 510 and a network device 520 serving the terminal device 510. The terminal device 510 may be implemented as the UE 110 discussed above, and the network device 120 may be implemented as the base station 120 discussed above.

Referring to FIG. 6, the terminal device 510 may comprise one or more processors 511, one or more memories 512 and one or more transceivers 513 interconnected through one or more buses 514. The one or more buses 514 may be address, data, or control buses, and may include any interconnection mechanism such as series of lines on a motherboard or integrated circuit, fiber, optics or other optical communication equipment, and the like. Each of the one or more transceivers 513 may comprise a receiver and a transmitter, which are connected to one or more antennas 516. The terminal device 510 may wirelessly communicate with the radio access network device 520 through the one or more antennas 516. The one or more memories 512 may include instructions 515 which, when executed by the one or more processors 511, may cause the terminal device 510 to perform operations and procedures relating to the UE 110 as described above.

The network device 520 may comprise one or more processors 521, one or more memories 522, one or more transceivers 523 and one or more network interfaces 527 interconnected through one or more buses 524. The one or more buses 524 may be address, data, or control buses, and may include any interconnection mechanism such as a series of lines on a motherboard or integrated circuit, fiber, optics or other optical communication equipment, and the like. Each of the one or more transceivers 523 may comprise a receiver and a transmitter, which are connected to one or more antennas 526. The network device 520 may operate as a base station for the terminal device 510 and wirelessly communicate with terminal device 510 through the one or more antennas 526. The one or more network interfaces 527 may provide wired or wireless communication links through which the network device 520 may communicate with other network devices, entities, elements or functions. For example, the network device 520 may communicate with a core network device (not shown) via backhaul connections. The one or more memories 522 may include instructions 525 which, when executed by the one or more processors 521, may cause the network device 520 to perform operations and procedures relating to the base station 120.

The one or more processors 511, 521 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 511, 521 may be configured to control other elements of the terminal/network device and operate in cooperation with them to implement the procedures discussed above.

The one or more memories 512, 522 may include at least one storage medium in various forms, such as a transitory memory and/or a non-transitory memory. The transitory memory may include, but not limited to, for example, a random access memory (RAM) or a cache. The non-transitory memory may include, but not limited to, for example, a read only memory (ROM), a hard disk, a flash memory, and the like. The term “non-transitory,” as used herein, is a limitation of the medium itself (i.e., tangible, not a signal) as opposed to a limitation on data storage persistency (e.g., RAM vs. ROM). Further, the one or more memories 512, 522 may include but not limited to an electric, a magnetic, an optical, an electromagnetic, an infrared, or a semiconductor system, apparatus, or device or any combination of the above.

Some exemplary embodiments further provide computer program instruction or instructions which, when executed by one or more processors, may cause a device or apparatus to perform the procedures described above. The program instruction for carrying out procedures of the exemplary embodiments may be written in any combination of one or more programming languages. The program instruction may be provided to one or more processors or controllers of a general purpose computer, special purpose computer, or other programmable data processing apparatus, such that the program instruction, when executed by the processor or controller, cause the functions/operations specified in the flowcharts and/or block diagrams to be implemented. The program instruction may execute entirely on a machine, partly on the machine, as a stand-alone software package, partly on the machine and partly on a remote machine or entirely on the remote machine or server.

Some exemplary embodiments further provide a computer program product or a computer readable medium having the program instruction or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1-44. (canceled)

45. A terminal device comprising:
at least one processor; and
at least one memory storing instructions that, when executed by the at least one processor, cause the terminal device at least to perform:
receiving, from a network device, a configuration for discontinuous transmission or reception of a cell supported by the network device, the configuration for discontinuous transmission or reception defining a discontinuous transmission or reception pattern including an active period and a non-active period, a first periodicity for transmission or reception during the active period, and a second periodicity for transmission or reception during the non-active period;
receiving, from the network device, an indication to activate the discontinuous transmission or reception in the cell;
performing reception or transmission of a signal or channel in the first periodicity during the active period; and
performing reception or transmission of the signal or channel in the second periodicity during the non-active period.

46. The terminal device of claim 45, wherein the configuration for discontinuous transmission or reception further defines at least one of the following:
one or more signals or channels to be transmitted or received during the active period, and
one or more signals or channels to be transmitted or received during the non-active period.

47. The terminal device of claim 45, wherein the first periodicity and the second periodicity are configured with a common offset relative to a reference time point, and the second periodicity is N times of the first periodicity where N is an integer greater than or equal to 1, so that transmission or reception occasions of the second periodicity overlaps with transmission or reception occasions of the first periodicity.

48. The terminal device of claim 47, wherein the terminal device applies the second periodicity from the first occasion of the first periodicity in the non-active period in a case where a time difference between a switching boundary from the active period to the non-active period and the first occasion of the first periodicity in the non-active period is less than or equal to a first threshold, or from the last occasion of the first periodicity in the active period in a case where the time difference between the switching boundary and the first occasion of the first periodicity in the non-active period is greater than the first threshold.

49. The terminal device of claim 47, wherein the terminal device applies the second periodicity from the last occasion of the first periodicity in the active period in a case where a time difference between the last occasion of the first periodicity in the active period and a switching boundary from the active period to the non-active period is less than or equal to a second threshold, or from the first occasion of the first periodicity in the non-active period in a case where the time difference between the last occasion of the first periodicity in the active period and the switching boundary is greater than the second threshold.

50. The terminal device of claim 47, wherein the terminal device applies the second periodicity from one of the last occasion of the first periodicity in the active period and the first occasion of the first periodicity in the non-active period which is closer to a switching boundary from the active period to the non-active period.

51. The terminal device of claim 45, wherein the second periodicity for transmission or reception during the non-active period is indicated by one or more occasions of the first periodicity to be skipped during the non-active period.

52. The terminal device of claim 45, wherein the configuration for discontinuous transmission or reception further indicates a starting point or defines a rule for determining the starting point from which the second periodicity is applied, or the starting point or the rule for determining the starting point is pre-defined at the terminal device.

53. The terminal device of claim 45, wherein the terminal device applies the second periodicity from a first occasion of the first periodicity in the non-active period, from a last occasion of the first periodicity in the active period, or from a switching boundary from the active period to the non-active period.

54. The terminal device of claim 45, wherein the second periodicity is configured with a separate offset relative to a reference time point, and the second periodicity is greater than or equal to the first periodicity.

55. A method implemented at a terminal device, comprising:
receiving, from a network device, a configuration for discontinuous transmission or reception of a cell supported by the network device, the configuration for discontinuous transmission or reception defining a discontinuous transmission or reception pattern including an active period and a non-active period, a first periodicity for transmission or reception during the active period, and a second periodicity for transmission or reception during the non-active period;
receiving, from the network device, an indication to activate the discontinuous transmission or reception in the cell;
performing reception or transmission of a signal or channel in the first periodicity during the active period; and
performing reception or transmission of the signal or channel in the second periodicity during the non-active period.

56. The method of claim 55, wherein the configuration for discontinuous transmission or reception further defines at least one of the following:
one or more signals or channels to be transmitted or received during the active period, and
one or more signals or channels to be transmitted or received during the non-active period.

57. The method of claim 55, wherein the first periodicity and the second periodicity are configured with a common offset relative to a reference time point, and the second periodicity is N times of the first periodicity where N is an integer greater than or equal to 1, so that transmission or reception occasions of the second periodicity overlaps with transmission or reception occasions of the first periodicity.

58. The method of claim 57, wherein the terminal device applies the second periodicity from the first occasion of the first periodicity in the non-active period in a case where a time difference between a switching boundary from the active period to the non-active period and the first occasion of the first periodicity in the non-active period is less than or equal to a first threshold, or from the last occasion of the first periodicity in the active period in a case where the time difference between the switching boundary and the first occasion of the first periodicity in the non-active period is greater than the first threshold.

59. The method of claim 57, wherein the terminal device applies the second periodicity from the last occasion of the first periodicity in the active period in a case where a time difference between the last occasion of the first periodicity in the active period and a switching boundary from the active period to the non-active period is less than or equal to a second threshold, or from the first occasion of the first periodicity in the non-active period in a case where the time difference between the last occasion of the first periodicity in the active period and the switching boundary is greater than the second threshold.

60. The method of claim 57, wherein the terminal device applies the second periodicity from one of the last occasion of the first periodicity in the active period and the first occasion of the first periodicity in the non-active period which is closer to a switching boundary from the active period to the non-active period.

61. The method of claim 55, wherein the second periodicity for transmission or reception during the non-active period is indicated by one or more occasions of the first periodicity to be skipped during the non-active period.

62. The method of claim 55, wherein at least one of:
the configuration for discontinuous transmission or reception further indicates a starting point or defines a rule for determining the starting point from which the second periodicity is applied, or the starting point or the rule for determining the starting point is pre-defined at the terminal device; or
the terminal device applies the second periodicity from a first occasion of the first periodicity in the non-active period, from a last occasion of the first periodicity in the active period, or from a switching boundary from the active period to the non-active period; or
the second periodicity is configured with a separate offset relative to a reference time point, and the second periodicity is greater than or equal to the first periodicity.

63. An apparatus comprising:
means for receiving, from a network device, a configuration for discontinuous transmission or reception of a cell supported by the network device, the configuration for discontinuous transmission or reception defining a discontinuous transmission or reception pattern including an active period and a non-active period, a first periodicity for transmission or reception during the active period, and a second periodicity for transmission or reception during the non-active period;
means for receiving, from the network device, an indication to activate the discontinuous transmission or reception in the cell;
means for performing reception or transmission of a signal or channel in the first periodicity during the active period; and
means for performing reception or transmission of the signal or channel in the second periodicity during the non-active period.
